(19) United States
(12) Patent Application Publication
(10) Pub. No.: US 2026/0209613 A1
(43) Pub. Date: Jul. 23, 2026

(54) SINGLE STEP CONVERSION OF ETHYLENE TO FUELS

(71) Applicant: EXXONMOBIL TECHNOLOGY AND ENGINEERING COMPANY, Spring, TX (US)

(72) Inventors: Matthew S. METTLER, Flemington, NJ (US); Yi DU, Coopersburg, PA (US); Yira Y. APONTE TORREALBA, Sarnia, CA (US); Doron LEVIN, Highland Park, NJ (US); Jennifer L. GREENE, Morristown, NJ (US); Michael P. LANCI, Flemington, NJ (US); Jarid M. METZ, Doylestown, PA (US)

(21) Appl. No.: 19/567,792

(22) Filed: Mar. 16, 2026

Related U.S. Application Data
(63) Continuation of application No. PCT/US2024/047164, filed on Sep. 18, 2024.
(60) Provisional application No. 63/584,089, filed on Sep. 20, 2023.

(51) Int. Cl. C10G 50/00; B01J 29/74

(52) U.S. Cl. CPC C10G 50/00; B01J 29/7476; C10G 2300/1092; C10G 2300/70; C10G 2400/08

(57) ABSTRACT

Systems and methods are provided for conversion of ethylene-containing feeds to fuels boiling range compounds, such as jet boiling range compounds. It has unexpectedly been discovered that improved conversion of ethylene-containing feeds can be achieved in a single stage at temperatures of 250° C. or less using a MWW framework catalyst that is substantially free of supported metals.

### FIELD

Methods are provided for single step conversion of ethylene to jet and/or fuels boiling range compounds in the presence of a strongly acidic catalyst that is substantially free of supported metals.

### CROSS REFERENCE TO RELATED APPLICATIONS

This application is a continuation of International Patent Application No. PCT/US2024/047164, filed 2024 Sep. 18, which claims the benefit of U.S. Provisional Application No. 63/584,089, filed 2023 Sep. 20. The entire contents of each of the foregoing applications are hereby incorporated by reference.

### BACKGROUND

One potential pathway for converting biomass to fuels is by forming methanol and/or ethanol from biomass and converting the methanol and/or ethanol to olefins. The olefins can then be oligomerized to form fuels boiling range compounds, such as jet boiling range compounds. Unfortunately, a variety of challenges remain for performing such oligomerization processes.

One of the difficulties for the oligomerization process is that ethylene corresponds to a substantial portion of the olefins produced from many types of alcohol conversion processes. For example, ethanol dehydration can produce a feed that contains up to 95 vol % ethylene, or possibly more. Methanol to olefins processes can also generate large quantities of ethylene. Ethylene is more difficult to react than C₃₊ olefins using solid acid catalysts without a supported metal, requiring high severity reaction conditions. However, such conditions can lead to increased catalyst deactivation, resulting in substantial shortening of run lengths. It would be desirable to have systems, methods, and corresponding catalysts that can allow for oligomerization under reduced severity conditions.

International Publication Number 2022/060353 describes MWW type zeolite catalysts. The catalysts are described in conjunction with processes for alkylation of isoparaffins with light olefins. The alkylation processes are described as being performed at isoparaffin to olefin volume ratios of 100 to 1 or greater.

U.S. Pat. Nos. 9,932,531 and 10,005,974 describe one-step and two-step processes for converting ethylene to fuels. The one-step oligomerization processes are described as requiring a temperature of 280° C. or greater. The two-step processes require a series of different catalysts for the oligomerization.

U.S. Pat. No. 4,433,185 describes performing olefin oligomerization over a limited group of zeolites including ZSM-5, ZSM-11, ZSM-12, ZSM-23, ZSM-35, and ZSM-38. It is noted that conversion of C₂ olefins is low when performing single stage oligomerization.

U.S. Pat. No. 7,183,450 describes performing olefin oligomerization over a variety of small and medium pore zeolitic framework structures. The medium pore framework structures include MFI, MEL, MTW, EUO, MTT, HEU, FER, AFO, AEL, and TON.

U.S. Pat. Nos. 4,542,251, 4,628,138 and 4,740,645 describe olefin oligomerization in the presence of catalyst corresponding to a catalytic metal or catalytic metal oxide supported on a zeolite substrate.

U.S. Pat. No. 4,227,992 describes oligomerization of olefin feeds in the presence of a ZSM-5 catalyst (MFI framework structure).

U.S. Pat. No. 5,600,048 describes alkylation and transalkylation of aromatic compounds with ethylene to form ethylbenzene.

### SUMMARY

In some aspects, a method of converting an ethylene-containing feed is provided. The method includes exposing a feed containing 5.0 wt % or more of ethylene to a catalyst including an MWW framework structure under conversion conditions. The conversion conditions can include a temperature of 250° C. or less. This results in formation of a conversion product containing C₉-C₁₆ components. The catalyst can have a) 0.75 wt % or less of Group 5-10 and Group 13 non-noble metals supported on the catalyst, and b) 0.05 wt % or less of Pt, Pd, or a combination thereof supported on the catalyst. The feed can have a molar ratio of ethylene to isoparaffins of 1.0 or more and a molar ratio of ethylene to aromatics of 1.0 or more.

### BRIEF DESCRIPTION OF THE DRAWINGS

FIG. 1 shows results from conversion of an ethylene feed in the presence of catalysts with various framework structures.

FIG. 2 shows comparative results for isoparaffin alkylation at elevated ratios of isoparaffin to olefin.

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, systems and methods are provided for conversion of ethylene-containing feeds to fuels boiling range compounds, such as jet boiling range compounds. It has unexpectedly been discovered that improved conversion of ethylene-containing feeds can be achieved in a single stage at temperatures of 250° C. or less using a MWW framework catalyst without a supported catalytic metal. It has been discovered that by using a MWW framework catalyst without a supported catalytic metal, improved rates of conversion of ethylene and/or improved yields of 165° C.+ products can be achieved during conversion in a single stage system while reducing or minimizing degradation of the catalyst. The reduced or minimized degradation of the catalyst is based in part on the reduced temperature for conversion. It is noted that although higher molecular weight products are formed during the conversion, the conversion is not strictly speaking an oligomerization reaction, as a substantial portion of the products correspond to product such as cycloparaffins, as opposed to the olefinic products generated when only an oligomerization reaction is performed.

Conventionally, oligomerization of ethylene has posed challenges due to the relatively low reactivity of ethylene compared to C₃₊ olefins. For processes designed to achieve meaningful oligomerization of ethylene, conventional methods have traditionally focused on one of three types of strategies. One strategy is to use elevated temperatures in a single oligomerization stage, such as temperatures greater than 250° C. By increasing the temperature, conventional catalysts can be used to achieve conversion rates that are better suited to commercial scale processes. However, increasing the oligomerization temperature also increases the rate at which conventional catalysts are degraded under oligomerization conditions. This reduces the potential run length, posing problems for commercial scale processes.

An alternative to increasing the temperature is increasing the activity of the catalyst by adding a catalytic metal to the catalyst. For example, in such a strategy, a Group 8-10 metal might be deposited on a zeolitic framework structure to provide a catalyst having higher oligomerization activity than the zeolitic framework structure alone. While this can be effective, such catalytic metals can also have a higher tendency to become deactivated. Additionally, requiring additional catalytic metals can substantially increase the cost of the catalyst.

Still a third option can be to expand the oligomerization process to include a plurality of stages containing different catalysts. Using multiple stages with different catalysts can allow a first stage to contain a catalyst that has better activity for converting C₂ olefins to C₃₊ olefins, such as a supported metal catalyst, while a second stage can include a second catalyst with better activity for oligomerization of C₃₊ olefins. Of course, having multiple stages adds to the complexity of a process.

In contrast to the above methods, it has been discovered that zeolitic catalysts having an MWW framework can be used for conversion processes at low temperatures while maintaining desirable conversion rates in a single stage for formation of higher molecular weight products. The MWW framework catalysts can be used without an additional supported catalytic metal, thus further improving catalyst lifetime while reducing cost.

It is noted that addition of a catalytic metal would not be inherently detrimental to the conversion process when using a solid acid catalyst, such as an MWW framework catalyst. However, to avoid poisoning a metal-based catalyst, impurities such as CO would need to be removed from the ethylene-containing feed to sufficiently low levels. By using a solid acid catalyst, such as a MWW framework catalyst, without a supported catalytic metal, the need to improve feed purity can be reduced, minimized, or eliminated, thus providing a substantial cost and energy savings for the overall process.

### Definitions

In this discussion, a zeolite is defined to refer to a crystalline material having a porous framework structure built from tetrahedra atoms connected by bridging oxygen atoms. Examples of known zeolite frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. In some aspects, a zeolite can correspond to an aluminosilicate having a zeolite framework structure. More generally, a zeolite can refer to aluminosilicates having a zeolite framework structure as well as zeolite framework structures containing oxides of atoms different from silicon and aluminum. Such oxides can include oxides of any other atoms generally known to be suitable for inclusion in a zeolite framework, such as oxides gallium, boron, germanium, phosphorus, zinc, and/or other transition metals that can substitute for silicon and/or aluminum in a zeolite framework. It is noted that under this definition, a zeolite can include materials such as silicoaluminophosphate (SAPO) materials or aluminophosphate (AlPO) materials.

In this discussion, references to a periodic table are defined as references to the current version of the IUPAC Periodic Table.

In this discussion, “noble metals” have the expected definition. Thus, noble metals are defined as Ru (Group 8), Os (Group 8), Rh (Group 9), Ir (Group 9), Pt (Group 10), Pd (Group 10), Au (Group 11), and Ag (Group 11). All other metals in Groups 5-14 are defined as non-noble metals. It is noted that Ga is a Group 13 metal.

### MWW Framework Catalysts

In various aspects, conversion of an ethylene-containing feed to form higher molecular weight products, such as C₉-C₁₆ hydrocarbons, can be performed as in a single stage process in the presence of a solid acid catalyst, such as a MWW framework catalyst (i.e., a catalyst containing a MWW framework structure material).

Examples of crystalline materials of the MWW framework type include, but are not limited to, MCM-22, PSH-3, SSZ-25, ERB-1, ITQ-1, ITQ-2, MCM-36, MCM-49, MCM-56, UZM-8, UZM-8HS, UZM-37, EMM-10, EMM-12, EMM-13, UCB-3, MIT-1, and any combination thereof. In some aspects, the MWW framework catalyst can correspond to EMM-10. In some aspects, an MWW framework catalyst can be an aluminosilicate material having a silica to alumina molar ratio of 10 or more, such as from 10 to 50. In other aspects, a MWW framework structure catalyst can have a framework structure that includes one or more atoms different from silicon, aluminum, and oxygen.

In various aspects, a catalyst and/or catalyst composition containing an MWW framework structure can be substantially free of catalytic metals supported on the catalyst. The amount of catalytic metal on a catalyst that corresponds to “substantially free” can vary depending on the nature of the metal. In some aspects, the catalyst and/or catalyst composition can have less than 0.75 wt % of Group 5-10 non-noble metals supported on the catalyst and/or catalyst composition, or 0.5 wt % or less, or 0.1 wt % or less, such as down to having substantially no supported Group 5-10 metals (0.0 wt % and/or detection limit), relative to a weight of the catalyst and/or catalyst composition. It is noted that this means that the combined amount of all Group 5-10 non-noble metals is less than the specified amount (i.e., less than 0.75 wt %, or 0.5 wt % or less, or 0.1 wt % or less). Additionally or alternately, the catalyst and/or catalyst composition can have less than 0.75 wt % of Group 5-10 and Group 13 non-noble metals, or 0.5 wt % or less, or 0.1 wt % or less, such as down to having substantially no supported Group 5-10 and Group 13 metals (0.01 wt % and/or detection limit). Further additionally or alternately, the catalyst and/or catalyst composition can have less than 0.75 wt % of Group 5-14 metals supported on the catalyst and/or catalyst composition, or 0.5 wt % or less, or 0.1 wt % or less, such as down to having substantially no supported Group 5-14 metals (0.001 wt % and/or detection limit), relative to a weight of the catalyst and/or catalyst composition. It is explicitly defined herein that a catalyst that is described as containing, including, or comprising less than a certain amount of a supported metal includes the situation where the catalyst includes none of the supported metal.

In some aspects, the catalyst and/or catalyst composition can have 0.05 wt % or less of Group 8-11 noble metals supported on the catalyst and/or catalyst composition, or 0.01 wt % or less, such as down to having substantially no Group 8-11 noble metals (0.001 wt % and/or detection limit). Additionally or alternately, the catalyst and/or catalyst composition can have 0.05 wt % or less of Pt, Pd, or a combination thereof, or 0.01 wt % or less, such as down to having substantially no Pt, Pd, or a combination thereof (0.001 wt % and/or detection limit).

In some aspects, catalysts and catalyst compositions described herein can include a binder. In other aspects, catalysts and catalyst compositions disclosed herein can include “self-bound” compositions that contain no, or substantially no, binder or additives. Self-bound catalysts (alternatively referred to as unbound or binder-free catalysts), are catalysts that do not contain a separately added matrix or binder material. The method described herein enables extrudates having high crush strength to be produced on conventional extrusion equipment and accordingly, the method is eminently suitable for producing the high activity self-bound catalysts. In some aspects, catalysts can “consist essentially of zeolite, and include no binder or additives and containing only unavoidable levels of impurities or non-active substances. Zeolite catalysts may be contaminated with other crystalline materials in some embodiments, such as ferrierite or quartz. These contaminants may be present in quantities of 10 wt % or less, such as 5.0 wt % or less.

In aspects where the catalyst composition includes a binder, the binder materials may include inorganic oxides, such as alumina, silica, titania, zirconia, and mixtures and compounds thereof, may be present in the catalyst in amounts 60 wt % or less, for example 50 wt % or less, such as 40 wt % or less, for example 30 wt % or less, such as 20 wt % or less, such as down to 1.0 wt % or possibly still lower. Where a non-alumina binder is present, the amount employed may be as little as 1.0 wt %, or 5.0 wt % or more, for example 10 wt % or more.

In aspects where the catalyst composition includes a binder, the catalyst composition can include a zeolite framework structure material in an amount of 30 wt % or greater, or 40 wt % or greater, or 50 wt % or greater, or 60 wt % or greater, or 70 wt % or greater, or 80 wt % or greater, or 90 wt % or greater, such as up to 99 wt % or possibly still higher. For example, the amount of zeolite framework structure material can be from 40 wt % to 99.99 wt %, from 50 wt % to 99.95 wt %, from 60 wt % to 99.9 wt %, from 70 wt % to 99.8 wt %, or from 80 wt % to 99.7 wt %.

The catalysts can be formed by any convenient method, including conventional extrusion, ion exchange, and calcination methods.

### Additional Catalysts

In some aspects, a conversion reaction stage can include a catalyst having an MWW framework structure and at least one additional catalyst. This can correspond to a catalyst system, where multiple types of catalyst particles are used, and/or this can correspond to a catalyst where an additional zeolite framework structure is present within a single type of catalyst particle.

In aspects where at least one additional zeolite framework structure is present in the conversion reaction stage, any convenient type of zeolite framework with activity for oligomerization and/or conversion can be used as the at least one additional zeolite framework structure material. Examples of other zeolite framework structures that can be used for oligomerization include, but are not limited to, MFI (e.g., ZSM-5), BEA (e.g., zeolite Beta), FAU (e.g., zeolite Y), MOR, FER, MCM-41, CHA (e.g., SAPO-34), and combinations thereof.

When additional catalyst particles are present that include at least one additional zeolite framework structure, in some aspects the additional catalyst particles can be substantially free of supported metals as described herein, such as being substantially free of Group 5-10 and Group 13 non-noble metals, and/or substantially free of Group 8-11 noble metals, and/or substantially free of Group 5-14 metals (non-noble and/or noble). In other aspects, the additional catalyst particles can include a supported metal.

In aspects where the additional catalyst particles include a supported metal, one option is to use a supported metal that corresponds to a hydrogenation catalyst. Examples of hydrogenation catalysts can include noble metals, such as Pd, Pt, Rh, Ru, Ir, Os, Ag, Au; or non-noble metals, such as Mo, Co, Ni, Fe; or any combination thereof, such as the combination of two noble metals, two non-noble metals, or a combination of noble and non-noble metals.

When one metal is present, the amount of the one metal can be 0.01 wt % to 5.0 wt %, based on the total weight of the additional catalyst particle, or 0.1 wt % to 5.0 wt %, or 0.5 wt % to 5.0 wt %, or 1.0 wt % to 5.0 wt %, or 0.01 wt % to 3.5 wt %, or 0.1 wt % to 3.5 wt %, or 0.5 wt % to 3.5 wt %, or 1.0 wt % to 3.5 wt %, or 0.01 wt % to 1.5 wt %, or 0.1 wt % to 1.5 wt %, or 0.5 wt % to 1.5 wt %.

When more than one hydrogenation metal is present, the collective amount of hydrogenation metals can be 0.01 wt % to 5.0 wt %, based on the total weight of the additional catalyst particle, or 0.1 wt % to 5.0 wt %, or 0.5 wt % to 5.0 wt %, or 1.0 wt % to 5.0 wt %, or 0.01 wt % to 3.5 wt %, or 0.1 wt % to 3.5 wt %, or 0.5 wt % to 3.5 wt %, or 1.0 wt % to 3.5 wt %, or 0.01 wt % to 1.5 wt %, or 0.1 wt % to 1.5 wt %, or 0.5 wt % to 1.5 wt %.

In aspects where both Pt and Pd are present as the hydrogenation metals, the molar ratio of Pt to Pd can be from 1:3 to 4:1, or from 1:4 to 3:1, or from 1:2 to 4:1, or from 1:2 to 3:1. The amounts of metal(s) may be measured by methods specified by ASTM for individual metals, including but not limited to, atomic absorption spectroscopy (AAS).

In some aspects, the additional catalyst particles can also include a support material or binder. Examples of suitable support materials and/or binders may include clay, alumina, silica, titania, zirconia, aluminosilicates, zeolites, carbon, and combination thereof. In some aspects, the silica support can be an amorphous silica support. In some aspects, the support can be a mesoporous crystalline or semi-crystalline support material. Examples of mesoporous silica materials suitable for use as a support can include, but are not limited to, zeolites, such as MCM-41, other M41S structures, SBA-15, and the like, and any combination thereof.

In aspects where the at least one additional catalyst is provided by having a catalyst system including multiple types of catalyst, the at least one additional catalyst and the catalyst having an MWW framework structure can be arranged in any convenient manner. In some aspects, the catalyst having the MWW framework structure and the at least one additional catalyst can correspond to a physical mixture of catalyst particles. Additionally or alternately, in some aspects a stacked bed arrangement can be used, so that the feed is contacted first with one type of catalyst particle (such as in one or more catalyst beds), followed by contacting the feed with another type of catalyst particle (such as in one or more additional catalyst beds, or in a downstream portion of a catalyst bed containing the first type of catalyst). In such aspects, a feed can be contacted first with the catalyst containing the MWW framework structure, or the feed can be contacted first with an additional catalyst.

Still another option can be to have a catalyst that is formulated so that the MWW framework structure and at least one additional zeolite framework structure are incorporated into a single catalyst particle.

In aspects where at least one additional catalyst is included in the conversion stage, any convenient amount of the MWW framework structure and the at least one additional catalyst can be used. In some aspects, a weight ratio of the MWW framework structure catalyst particles to the particles of the at least one additional catalyst can be 0.2 to 10, or 0.33 to 10, or 0.5 to 10, or 1.0 to 10, or 0.2 to 5.0, or 0.33 to 5.0, or 0.5 to 5.0, or 1.0 to 5.0.

### Feedstock and Reaction Conditions

In various aspects, a MWW framework catalyst (and/or other solid acid catalyst) can be used for conversion of an ethylene-containing feed. Depending on the aspect, the feedstock can also include other components, including but not limited to, C₃₊ olefins, isoparaffins, aromatics, impurities such as CO, and other components such as H₂ and/or n-alkanes.

The ethylene (C₂ olefin) content of the feedstock can vary depending on the source of the feed. In some aspects where a high ethylene-content feedstock is used, the ethylene-containing feed can correspond to a feedstock with an ethylene content of 85 wt % or more, or 90 wt % or more, or 95 wt % or more, such as up to being substantially a pure ethylene feedstock. In such aspects, the molar ratio of ethylene to any other single component in the feed can be 5.0 or more (i.e., 5: 1), or 8.0 or more, or 10 or more, such as up to 500 (or possibly still higher as the ethylene purity in the feedstock approaches 100 wt % ethylene).

It is noted that for molar ratios of ethylene to another component as defined herein, if a feed is specified as having a molar ratio of ethylene to a component that is greater than a target value, such a feed is defined to satisfy that molar ratio of the component is not present in the feed. For example, a statement that a feed has a molar ratio of ethylene to isoparaffins of greater than 10 includes the situation where the feed does not contain any isoparaffins. As another example, a statement that a feed has a molar ratio of ethylene to C₃ olefins of 1.0 or more includes the situation where the feed does not contain any C₃ olefins.

More generally, the ethylene-containing feed can have an ethylene content of 1.0 wt % or more, or 5.0 wt % or more, or 10 wt % or more, or 25 wt % or more, or 35 wt % or more, or 50 wt % or more, or 75 wt % or more, such as up to 100 wt %. In various aspects, the ethylene-containing feed can have a molar ratio and/or volume ratio of ethylene to isoparaffins of 1.0 or more, or 2.0 or more, or 5.0 or more, such as up to 500 or possibly still higher. Additionally or alternately, the ethylene-containing feed can have a molar ratio and/or volume ratio of ethylene to aromatics of 1.0 or more, or 2.0 or more, or 5.0 or more, such as up to 500 or possibly still higher.

It is noted that in some aspects, the ethylene-containing feed can be combined with a recycle stream. The recycle stream can correspond to one or more fractions that are separated from the conversion product. In such aspects, the conversion product can include C₂-C₄ hydrocarbons, and/or C₅-C₈ hydrocarbons, and/or C₂-C₈ hydrocarbons. For example, a fraction containing C₂-C₄ hydrocarbons can be separated from the conversion product, and/or a fraction containing C₅-C₈ hydrocarbons can be separated from the conversion product and/or a fraction containing C₂-C₈ hydrocarbons can be separated from the conversion product. At least a portion of one or more of the above types of fractions can be recycled. This can result in a combined feed (fresh feed plus recycle) that will have a lower olefin content than the fresh feed alone.

The ethylene-containing feed can also contain other olefins. In various aspects, the ethylene-containing feed can have a total olefin content of 10 wt % to 100 wt %, or 30 wt % to 100 wt %, or 50 wt % to 100 wt %, or 10 wt % to 70 wt %, or 30 wt % to 70 wt %, or 10 wt % to 40 wt %. Additionally or alternately, in some aspects, the ethylene-containing feed can include 5.0 wt % or less of C₉₊ olefins relative to a weight of the ethylene-containing feed.

In some aspects, the weight ratio of ethylene (C₂ olefin) to C₃ olefins can be 0.05 or more, or 0.2 or more, or 0.5 or more, or 1.0 or more, or 2.0 or more, such as up to 100 or possibly still higher. Additionally or alternately, the weight ratio of ethylene to combined C₃ and C₄ olefins can be 0.1 or more, or 0.2 or more, or 0.5 or more, or 1.0 or more, or 2.0 or more, such as up to 100 or possibly still higher. Further additionally or alternately, the weight ratio of ethylene to combined C₃ to C₈ olefins can be 0.2 or more, 0.5 or more, or 1.0 or more, or 2.0 or more, such as up to 100 or possibly still higher.

In some aspects, the ethylene-containing feed can correspond to a feed that includes CO as a contaminant. For example, some methanol to olefin processes can produce CO as a minor product along with ethylene. In various aspects, the ethylene-containing fee can have a CO content of 100 wppm to 5000 wppm, or 100 wppm to 2500 wppm, or 100 wppm to 1000 wppm, or 250 wppm to 5000 wppm, or 250 wppm to 2500 wppm, or 250 wppm to 1000 wppm, or 500 wppm to 5000 wppm, or 500 wppm to 2500 wppm.

Additionally or alternately, other contaminants can also be present in the ethylene-containing feed. The contaminants can correspond to one or more C₁-C₈ compounds that are not alkenes or alkanes. Examples of contaminants include alkynes (e.g., acetylene, methyl-acetylene), dienes (e.g., propadiene, butadienes, hexadienes), and oxygenates (ethers, aldehydes, and ketones).

In some aspects, the ethylene-containing feed can include n-alkanes. In such aspects, the ethylene-containing feed can also contain 1.0 wt % to 90 wt % of n-alkanes, or 1.0 wt % to 50 wt %, or 1.0 wt % to 20 wt %, or 10 wt % to 90 wt %, or 10 wt % to 50 wt %, or 30 wt % to 90 wt %.

In some aspects, the ethylene-containing feed can include H₂. In such aspects, the ethylene-containing feed can contain 10 wt % or less of H₂, or 1.0 wt % or less, or 0.1 wt % or less, such as down to substantially no H₂ content (0.001 wt % or less).

### Conversion Conditions

In various aspects, the ethylene-containing feed is exposed to an MWW framework catalyst under conversion conditions that include a single reaction stage and an a conversion temperature of 250° C. or less, such as a temperature of 180° C. to 250° C.

In this discussion, a reaction stage is defined as one or more catalyst beds that are exposed to a feed without separation between the one or more catalyst beds. The beds can be arranged in multiple vessels if the effluent from one vessel is cascaded to a second vessel without separation. In other aspects, the one or more catalyst beds can be contained in a single reaction vessel. A stage can include quench flows and/or input feed flows between catalyst beds to maintain a target temperature.

The one or more catalyst beds can contain a single catalyst, or a plurality of catalysts can be used. If a plurality of catalysts is used, the plurality of catalysts can be arranged in any convenient manner within the catalyst beds. This can include arranging the catalyst so that a feed is exposed to a first catalyst followed by a second catalyst; or arranging the catalyst so that at least a portion of the one or more catalyst beds corresponds to a mixture of particles of a first catalyst and particles of a second catalyst; or a combination thereof. Still another option is to formulate a catalyst composition where individual particles of the catalyst composition include both a first catalyst and a second catalyst. In various aspects, at least one catalyst of the plurality of catalyst can correspond to a MWW framework structure catalyst.

In various aspects, during conversion, the weighted average bed temperature (WABT) for each catalyst bed of the one or more catalyst beds in a stage can be maintained at a temperature 180° C. to 250° C., or 180° C. to 230° C., or 200° C. to 250° C., or 200° C. to 230° C. In this discussion, the weighted average bed temperature for a catalyst bed is defined as the average of the temperature of the feed at the top of the catalyst bed and the temperature of the effluent at the bottom of the catalyst bed. It is noted that as a run progresses, higher temperatures may be used to extend run length as the catalyst deactivates.

The pressure during conversion can be any convenient pressure. In some aspects, the pressure during conversion can be 0.1 MPa-a to 10 MPa-a, or 0.1 MPa-a to 7.0 MPa-a, or 0.1 MPa-a to 3.5 MPa-a, or 1.0 MPa-a to 10 MPa-a, or 1.0 MPa-a to 7.0 MPa-a, or 1.0 MPa-a to 3.5 MPa-a. The weight hourly space velocity (WHSV) for the ethylene-containing feed can be between 0.1 hr⁻¹ to 10 hr⁻¹. Additionally or alternately, the weight hourly space velocity for just the olefin in the feed can be between 0.05 hr⁻¹ to 5.0 hr⁻¹.

In various aspects, the conversion conditions can allow for conversion of 30 wt % or more of the ethylene in the feed, or 40 wt % or more, or 50 wt % or more, or 60 wt % or more, or 70 wt % or more, such as up to substantially complete conversion of ethylene. In this discussion, conversion of a feed component (such as ethylene) is defined as the weight ratio of the weight of the feed component in the products relative to the weight of the feed component in the initial feed. For continuous processes, this weight comparison can be made based on an average weight per unit time (such as grams per minute) of the feed component in the product relative to the weight per unit time of the feed component in the feed.

In various aspects, the yield of 165° C.+ products, relative to the weight of ethylene in the feed, can be 30 wt % or more, or 40 wt % or more, such as up to 80 wt % or possibly still higher.

It is noted that conversion of ethylene in the presence of an MWW framework catalyst that is substantially free of conventional supported catalytic metals can result in an unexpected product distribution. For example, conversion of ethylene in the presence of an MWW catalyst that is substantially free of conventional supported catalytic metals can result in unexpected production of C₅-C₉ cyclopentanes. Such C₅-C₉ cyclopentanes correspond to naphtha boiling range products. Such cyclopentanes are not observed when a feed does not contain ethylene. Similarly, production of such cyclopentanes is reduced, minimized, or eliminated when conversion is performed without an MWW catalyst and/or when the MWW catalyst includes a conventional amount of a supported catalytic metal.

Production of cycloparaffins such as cyclopentanes can provide various advantages relative to typical oligomerization products. For example, oligomerization products typically include a high percentage of olefins. Such olefins typically need to be saturated prior to use of the oligomerized product. This requires additional hydrogen. By contrast, cycloparaffins generated by a conversion reaction do not require subsequent hydrogenation prior to use. When used as a fuel, cycloparaffins can also provide benefits similar to aromatics with regard to maintaining seal integrity in the presence of the fuel.

In various aspects, when a feed containing 20 wt % or more of ethylene is converted in the presence of an MWW catalyst that is substantially free of a conventional supported catalytic metal, the resulting oligomerized effluent can include 8.0 wt % or more of C₅-C₉ cyclopentanes (relative to a weight of the feed), or 10 wt % or more, or 14 wt % or more, or 18 wt % or more, such as up to 30 wt % or possibly still higher.

Additionally or alternately, conversion of ethylene using an MWW framework catalyst that is substantially free of a conventional supported catalytic metal can unexpectedly result in production of 1,1-dimethylcyclopentane. This compound has a C₅ ring structure plus a quaternary carbon. It is unexpected to produce such a compound during conversion of olefins, and it is believed to be a signature of performing conversion using an MWW catalyst that is substantially free of a conventional supported catalytic metal. In various aspects, a feed containing 5.0 wt % or more of ethylene (or 20 wt % or more of ethylene) can be converted in the presence of an MWW catalyst that is substantially free of conventional supported catalytic metals to form 2.0 wt % or more of 1,1-dimethylcyclopentane (relative to a weight of the feed), or 4.0 wt % or more, or 8.0 wt % or more, such as up to 15 wt % or possibly still more.

### Example 1—Comparison of MWW Framework Catalyst (EMM-10) with MFI Framework Catalyst

A catalyst substantially composed of EMM-10 catalyst, as described in International Publication Number 2022/060353, was used as a representative MWW framework structure catalyst for performing low temperature conversion of an ethylene-containing feed. Table 1 shows the reaction conditions used for conversion of a feed substantially composed of ethylene. For comparison, Table 1 also includes a prior conversion (oligomerization) that was performed using a ZSM-5 catalyst (MFI framework structure), as described in U.S. Pat. No. 4,227,992. In Table 1, for the examples from U.S. Pat. No. 4,227,992, the pressure during oligomerization was 400 psig (~2.8 MPa-g). The pressure for the EMM-10 conversions was between 950 psig to 970 psig (~6.6 MPa-g to ~6.7 MPa-g).

TABLE 1
Comparison of Conversion with MWW and MFI catalysts

| | U.S. Pat. | U.S. Pat. | EMM-10 | EMM-10 |
|---|---|---|---|---|
| | No. 4,227,992, | No. 4,227,992, | Condition 1 | Condition 2 |
| | Example #1 | Example #2 | (inventive) | (inventive) |
| Catalyst | ZSM-5B | ZSM-5B | EMM-10 | EMM-10 |
| Temperature | 600° F. | 600° F. | 392° F. | 437 F. |
| | (316° C.) | (316° C.) | (200° C.) | (225° C.) |
| WHSV (olefin) | 0.4 hr−1 | 0.5 hr−1 | 0.3 hr−1 | 1.6 hr−1 |
| C2= Conversion | 70% | 74% | 37% | 67% |
| Yield, 165° C.+ | 30% | 32% | 46% | 37% |
| (Jet + Diesel) | (of TLP) | (of TLP) | | |

As shown in Table 1, at a temperature of 316° C., the ZSM-5 catalyst was able to convert 70% or more of the ethylene in the feed, but the yield of 165° C.+ compounds (i.e., jet plus diesel compounds) was only 30 wt % to 32 wt % of the total liquid product. By contrast, the EMM-10 catalyst was able to achieve nearly 70% conversion of the ethylene at the substantially lower temperature of 225° C. while also providing a superior yield of 165° C.+ compounds in the total liquid product. Additional increase in yield was achieved by reducing the conversion temperature to 200° C. The results in Table 1 demonstrate the unexpected ability of an MWW framework catalyst to perform substantial ethylene conversion with high yield of 165° C.+ products at conversion temperatures below 250° C.

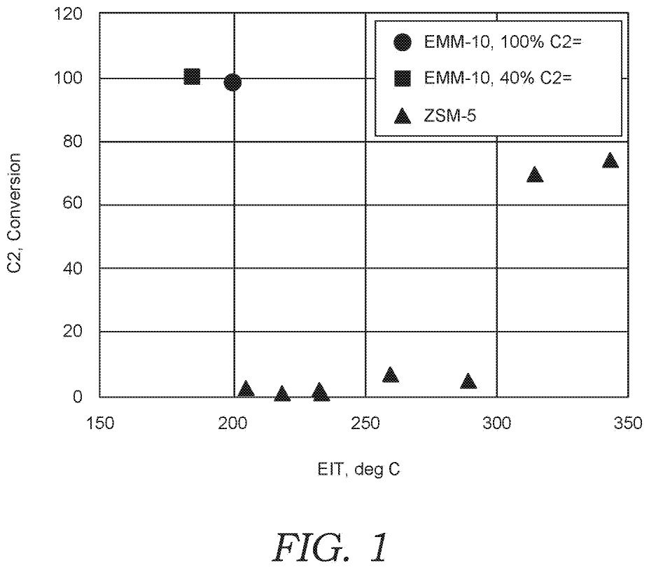

FIG. 1 shows results from additional conversion reactions performed with a ZSM-5 catalyst similar to the catalyst used in Table 1, and with the EMM-10 catalyst used in Table 1. Similar to the results in Table 1, the feed was a substantially pure ethylene feed. As shown in FIG. 1, the ZSM-5 catalyst has little or no activity for conversion of ethylene at temperatures below 300° C., a reaction pressure of 400 psig (2.8 MPa-g), and a weight hourly space velocity (WHSV) between 0.8 hr⁻¹ and 1.2 hr⁻¹. By contrast, up to greater than 99% conversion and/or up to 100% conversion of ethylene can be achieved at temperatures between 180° C. and 200° C. with the EMM-10 conversion catalyst.

### Example 2—Qualitative Comparison of Conversion Conditions with Alkylation Conditions

International Publication Number 2022/060353 describes using MWW type zeolite catalysts for alkylation of isoparaffins with light olefins. The volume ratio of isoparaffins to olefins for the alkylation process is 100 or greater. As a result, isoparaffin alkylation is a qualitatively different process relative to the conversion processes described herein, where the molar ratio and/or volume ratio of olefins to isoparaffins is 1.0 or greater (and therefore the molar ratio and/or volume ratio of isoparaffins to olefins is 1.0 or less).

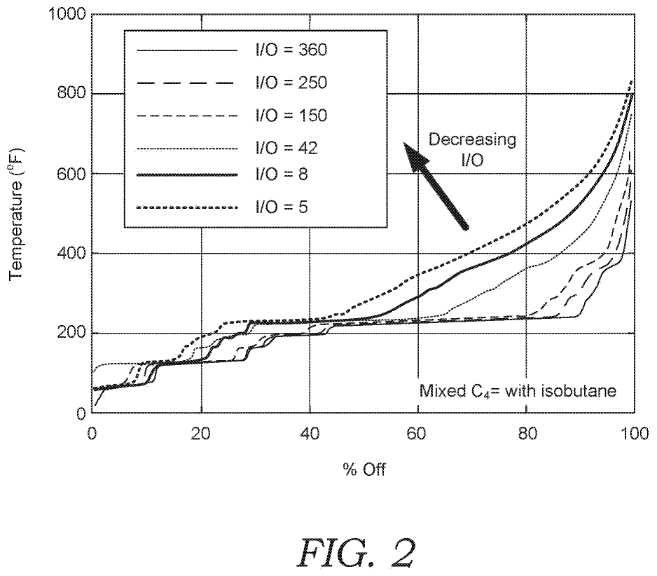

FIG. 2 illustrates the qualitative difference between isoparaffin alkylation conditions and conditions that start to approach conversion conditions as described herein. In FIG. 2, a series of isoparaffin alkylation reactions are shown where the alkylation is performed using an MWW catalyst under conditions similar to those described in International Publication Number WO/2022/060353. The reactions were performed using a series of isoparaffin to olefin volume ratios in the feed, with the isoparaffins corresponding to isobutane (C₄H₁₀) while the olefins corresponded to a mixture of C₄ olefins. FIG. 2 shows boiling point profiles for the total reaction product at the various ratios of isoparaffins to olefins. Although FIG. 2 shows alkylation using C₄ olefins, it is understood that C₄ olefins have higher reactivity for conversion, and therefore the lower rates of conversion would be expected when using C₂ olefins. It is noted that the expected reaction product from alkylation of iosbutane with C₄ olefins is a C₈ product, which would be expected to have a boiling point of roughly 100° C. In the case of isoparaffin/olefin alkylation with high isoparaffin to olefin ratios, the primary product observed is a C₈ isoparaffin, which largely does not undergo additional reaction. In the case of low isoparaffin to olefin ratios where two C₄ olefins react, the primary product is a C₈ olefin, the opposite is true; the C₈ olefin is reactive and will continue to build molecular weight to heavier products. This is a substantial difference in the reaction mixtures between 2022/060353 and this application.

As shown in FIG. 2, at isoparaffin to olefin ratios of 100 or greater, substantially no conversion to C₉₊ compounds occurs. This can be seen based on the fact that more than 80% of the total liquid product boils at a temperature of roughly 220° F. (~105° C.), which corresponds to an alkylation product, not an oligomerization product and/or other type of higher boiling product. Based on this, little or no conversion would be expected when using an MWW framework catalyst in the presence of ethylene at isoparaffin to olefin ratios of 100 or greater. As the isoparaffin to olefin ratio is reduced to values substantially below 100, the amount of higher boiling products is increased. But again, it is noted that FIG. 2 is based on a feed containing C₄ olefins instead of C₂ olefins, so based on FIG. 2 alone, one of skill in the art would not be able to identify the unexpected activity of MWW catalysts for conversion of C₂ olefins.

### Example 3—Ethylene Conversion in Mixed Olefin Feed

Table 2 shows results from conversion of a mixed olefin feed in the presence of an EMM-10 catalyst. For the results shown in Table 2, the first two columns correspond to conversion of a feed containing 11 wt % ethylene, 21 wt % propylene, 17 wt % of C₄ olefins, 17 wt % of C₅ olefins, and 34 wt % of C₈ olefins. For the third column, the same feed was used as a starting point, but additional ethylene was added until a total ethylene content of 40 wt % was achieved for the feed.

TABLE 2
Conversion of Mixed Olefin Feed

| Feed | 10 wt % C2= | 10 wt % C2= | 40 wt % C2= |
|---|---|---|---|
| Catalyst wt, g | 1 | 1 | 1 |
| Temperature, ° C. | 149 | 199 | 199 |
| Press (MPa-g) | 6.7 | 6.7 | 6.7 |
| Total Olefin | 2 | 2 | 2.1 |
| WHSV (hr⁻¹) | | | |
| C2= % Conv | 69.2% | 99.8% | 78.2% |
| C3= % Conv | 100.0% | 100.0% | 99.9% |
| C4= % Conv | 99.9% | 99.9% | 99.5% |
| C5= % Conv | 94.9% | 99.5% | 98.4% |

As shown in Table 2, substantially complete conversion of ethylene can be achieved during conversion of a mixed olefin feed at a temperature of roughly 200° C. Even at roughly 150° C., the EMM-10 catalyst can convert 70% of the ethylene in a mixed olefin feed when 10% of ethylene is present in the feed. As shown in the third column, as the amount of ethylene in the feed is increased, the conversion rate is reduced, so that for the feed containing 40 wt % ethylene, roughly 80% of the ethylene is converted. As shown in Table 2, substantially all of the C₃₊ olefins were converted under the reaction conditions.

### Example 4—Conversion of Feeds Containing Isoparaffins and/or Aromatics

Table 3 shows results from performing conversion in the presence of EMM-10 with a feedstock containing a mixture of ethylene and isoparaffins. As shown in Table 3, the feed corresponded to a mixture of 69 wt % ethylene and 31 wt % isobutane. This corresponds to a molar ratio of ethylene to isobutane of between 4.0 and 5.0. The conversion was performed at the temperatures shown in Table 3, with a pressure of 6.5 MPa-g and a WHSV for the total feed of 0.6 hr⁻¹.

TABLE 3
Conversion of Mixture of Ethylene and Isobutane

| Temperature | 185° C. | 200° C. |
|---|---|---|
| Feed C2= | 61 w % | 61 w % |
| Feed isoparaffin (iC4) | 39 w % | 39 w % |
| C2= Conversion | 40% | 70% |
| Isoparaffin Conversion | 15% | 34% |

As shown in Table 3, at both 185° C. and 200° C., the EMM-10 catalyst is able to convert a substantial portion of the ethylene in the mixed feed. The amount of isoparaffin conversion is smaller than the amount of ethylene conversion at both conversion temperatures.

MWW framework catalysts can also convert ethylene in the presence of aromatics. Table 4 shows results from performing conversion in the presence of EMM-10 with a feedstock containing a mixture of ethylene and aromatics. As shown in Table 4, the feed corresponded to a mixture that included 28 wt % ethylene and roughly 2.8 wt % aromatics. The balance of the feed corresponded to n-paraffins and isoparaffins, with a ratio of ethylene to isoparaffins of at least 1.0. The conversion was performed at a temperature of 180° C. and a pressure of 6.5 MPa-g.

TABLE 4
Conversion of Mixture of Ethylene and Aromatics

| Temperature | 180° C. | |
|---|---|---|
| Feed C2= | 28 | wt % |
| Feed C6-C8 Aromatics | 1.77 | wt % |
| Feed C9+ Aromatics | 0.97 | wt % |
| Product C6-C8 Aromatics | 0.12 | wt % |
| Product C9+ Aromatics | 5.01 | wt % |

| | |
|---|---|
| C2= Conversion | 99% |
| C6-C8 Aromatics | 93% |
| Conversion | |

As shown in Table 4, the presence of small amounts of aromatics does not interfere with conversion of ethylene, as substantially complete conversion was achieved at a temperature of 180° C. It is noted that alkylation of the C₆-C₈ aromatics appeared to also occur, based on the substantially complete conversion of the C₆-C₈ aromatics.

### Example 5—Formation of Cyclopentanes During Conversion

A series of feeds were exposed to EMM-10 under conversion conditions. The feeds corresponded to olefinic feeds for conversion that contained either 100 wt % ethylene (Case A), roughly 40 wt % ethylene (Case B), or 0 wt % ethylene (Case C). The naphtha boiling range portion of the conversion effluent was characterized using GC-MS and GC-FID. Table 5 shows details from the conversion reactions.

TABLE 5
Conversion and Formation of Cyclopentanes

| | Case A | | Case B | | Case C | |
|---|---|---|---|---|---|---|
| Feed C₂= | 100 | wt % | 38.7 | wt % | 0 | wt % |
| Feed C₃= and Other | | | 61.3 | wt % | 100 | wt % |
| Temperature | 213° | C. | 197° | C. | 197° | C. |
| Pressure | 6.6 | MPa-g | 6.6 | MPa-g | 6.6 | MPa-g |
| WHSV | 0.5 | hr⁻¹ | 0.5 | hr⁻¹ | 0.5 | hr⁻¹ |

| C₂= conversion | 87.5% | | 99+% | | |
|---|---|---|---|---|---|
| C₃-C₅= conversion | | | 99% | | 99% |
| Yield, C₅-C₉ | 21.8 | wt % | 14.8 | wt % | 0 |
| Cyclopentanes | | | | | |
| Yield, 1,1-dimethyl | 11.1 | wt % | 5.5 | wt % | 0 |
| cyclopentane | | | | | |

As shown in Table 5, C₅-C₉ cyclopentanes were not formed from the conversion feed that only included C₃₊ olefins. For the pure ethylene feed (Case A), more than 20 wt % of cyclopentanes were formed relative to the weight of the feed, including more than 10 wt % of 1,1-dimethylcyclopentane. It is noted that reducing the ethylene content to 40 wt % of the feed (Case B) still resulted in production of nearly 15 wt % of cyclopentanes and 5.5 wt % of 1,1-dimethylcyclopentane. Thus, dropping the ethylene content by more than half resulted in a drop in cyclopentane production of roughly only 33%.

In this discussion, the amount of naphtha boiling range cyclopentanes in the conversion product, including 1,1-dimethylcyclopentane, can be determined using a combination of gas chromatography—mass spectrometry (GC-MS) and gas chromatography—flame ionization detection (GC-FID).

To perform the data analysis shown in Table 5, both the gas phase product and the total liquid product were characterized.

To analyze the products from the conversion reaction, the total reactor effluent was sent to a knock out pot kept at 40° F. (4° C.). The offgas from this pot was analyzed using the gas phase analysis method below. The liquid remaining in the pot was collected and analyzed using the liquid phase analysis method below. In this discussion, analysis of cycloparaffin content (including content of individual cyclopentane compounds) can be performed using the gas phase analysis and liquid phase analysis methods.

The gas phase products were characterized by performing three parallel analyses. The first is a hydrocarbon analysis using a Petrocol DH gas chromatography column and a FID. For H₂ analysis, a detector was used with a Hapsep T/Molesieve 13× packed column set and a thermal conductivity detector. The remaining components of the gas (such as fixed/inert gases) where characterized with a Hapsep N/Molesieve 5A packed column set which separates the fixed/inert gases, along with a thermal conductivity detector.

An initial front inlet corresponded to an inlet operated in split mode with a 100:1 split. The inlet was operated at 250° C. with a septum purge of 3 mL/min.

The columns for the various analyses were contained in an oven to control temperature during the characterization. The oven temperature started at 35° C., and was held at that temperature for 15 min. The temperature was then ramped at 15° C./min to 150° C., and then held for 7.3 min. The temperature was then ramped at 15° C./min to 250° C., and held for 20 min.

For the hydrocarbon analysis, a 150 m×0.25 mm ID×1 μm film Petrocol was used. An He carrier gas was used. The column was operated in constant pressure mode at 65 psi (flow will change in the column during temperature ramps). The output from the column was passed into a flame ionization detector. The FID was operated at 275° C.; 40 mL/min H₂; 400 mL/min zero air; makeup of 28 mL/min; and a data rate of 50 Hz.

For the analysis of the remaining gas phase components, a combination of a 9′ Haysep N 80/100 Packed Column and 9′ MoleSieve 5A 45/60 Packed Column was used. The carrier gas was He. Different pressure programs were used for each column. The TCD was operated at 200° C. with a reference flow of 42 mL/min. The filament and negative polarity were on. The data rate was 20 Hz.

For the analysis of H₂ content, a combination of a 4′ Haysep T 80/100 Packed Column and a 9′ MolSieve 13λ 45/60 Packed Column were used. The carrier gas was N₂. The columns were operated at 40 psi. The TCD was operated at 200° C. with a reference flow of 42 mL/min and the filament was on. The data rate was 20 Hz.

For the liquid phase analysis, liquid hydrocarbon samples were injected onto a Petrocol DH column and associated FID. It is noted that the retention time of 1,1-dimethylcyclopentane was roughly 17.69 minutes.

An initial front inlet corresponded to an inlet operated in split mode with a 150:1 split. The inlet was operated at 280° C. with a septum purge of 3 mL/min. The column was a 150 m×0.25 mm ID×1 μm film Petrocol column, with H₂ as the carrier gas. The column was operated in constant pressure mode at 60 psi (flow will change in the column during temperature ramps). The temperature in the column was maintained using an oven. The oven was started at 60° C. The temperature was then ramped at 0.5° C./min to 270° C., followed by holding that temperature for 30 min. The FID was operated at 310° C.; 40 mL/min H₂; 400 mL/min zero air; makeup of 30 mL/min; and a data rate of 20 Hz.

### Additional Embodiments

Embodiment 1. A method of converting an ethylene-containing feed, comprising: exposing a feed comprising 5.0 wt % or more of ethylene to a catalyst comprising an MWW framework structure under conversion conditions comprising a temperature of 250° C. or less to form a conversion effluent comprising C₉-C₁₆ components, the catalyst comprising a) 0.75 wt % or less of Group 5-10 and Group 13 non-noble metals supported on the catalyst, and b) 0.05 wt % or less of Pt, Pd, or a combination thereof supported on the catalyst, the feed comprising a molar ratio of ethylene to isoparaffins of 1.0 or more and a molar ratio of ethylene to aromatics of 1.0 or more.

Embodiment 2. The method of Embodiment 1, wherein the conversion product further comprises a naphtha boiling range portion, the naphtha boiling range portion of the conversion product comprising 10 wt % or more of cyclopentanes, or 2.0 wt % or more of 1,1-dimethylcyclopentane, or a combination thereof.

Embodiment 3. The method of any of the above embodiments, wherein the catalyst comprises 0.5 wt % or less of Group 5-10 and Group 13 non-noble metals supported on the catalyst.

Embodiment 4. The method of any of the above embodiments, wherein the conversion product further comprises at least one of C₂-C₄ hydrocarbons, C₅-C₈ hydrocarbons, and C₂-C₈ hydrocarbons, the method further comprising separating the conversion product to form at least one of a fraction comprising C₂-C₄ hydrocarbons, a fraction comprising C₅-C₈ hydrocarbons, and a fraction comprising C₂-C₈ hydrocarbons, wherein the feed comprises at least a portion of the at least one of a fraction comprising C₂-C₄ hydrocarbons, a fraction comprising C₅-C₈ hydrocarbons, and a fraction comprising C₂-C₈ hydrocarbons.

Embodiment 5. The method of any of the above embodiments, wherein exposing the feed to conversion conditions comprises exposing the feed to conversion conditions in a single reaction stage.

Embodiment 6. The method of any of the above embodiments, wherein the feed comprises a molar ratio of olefins to isoparaffins of 5.0 or more, or wherein the feed comprises a molar ratio of olefins to aromatics of 5.0 or more, or a combination thereof.

Embodiment 7. The method of any of the above embodiments, wherein the feed comprises 30 wt % or more of ethylene.

Embodiment 8. The method of any of the above embodiments, wherein the feed comprises 50 wt % or more of olefins, or wherein the feed comprises a molar ratio of ethylene to C₃ olefins of 0.05 or more, or a combination thereof.

Embodiment 9. The method of any of the above embodiments, wherein the feed comprises no isoparaffins, or wherein the feed comprises no aromatics, or a combination thereof.

Embodiment 10. The method of any of the above embodiments, wherein the catalyst comprises EMM-10, or wherein the MWW framework structure comprises an aluminosilicate, or a combination thereof.

Embodiment 11. The method of any of Embodiments 1-9, wherein the MWW framework structure comprises one or more atoms different from silicon, aluminum, and oxygen.

Embodiment 12. The method of any of the above embodiments, wherein the catalyst comprises 0.5 wt % or less of Group 5-14 non-noble metals supported on the catalyst, or wherein the catalyst comprises 0.01 wt % or less of Group 8-11 noble metals supported on the catalyst, or a combination thereof.

Embodiment 13. The method of any of the above embodiments, wherein the feed comprises 100 wppm or more of CO.

Embodiment 14. The method of any of the above embodiments, wherein the conversion conditions comprise an ethylene conversion of 30% or more.

Embodiment 15. The method of any of the above embodiments, wherein the feed is exposed to a catalyst system under the conversion conditions, the catalyst system comprising i) the catalyst comprising the MWW framework structure, and ii) at least one additional catalyst.

Embodiment 16. The method of any of the above embodiments, wherein the catalyst comprising the MWW framework structure further comprises at least one additional zeolite framework structure.

Embodiment 17. The method of any of the above embodiments, wherein the conversion product comprises a 30 wt % or higher yield of 165° C.+ compounds relative to a weight of ethylene in the feed.

Additional Embodiment A. The method of any of the above embodiments, wherein the catalyst comprising the MWW framework structure further comprises a binder.

Additional Embodiment B. A method of converting an ethylene-containing feed, comprising: exposing a feed comprising 5.0 wt % or more of ethylene to a catalyst comprising a solid acid catalyst under conversion conditions comprising a temperature of 250° C. or less to form a conversion effluent comprising C₉-C₁₆ components, the catalyst comprising a) 0.75 wt % or less of Group 5-10 and Group 13 non-noble metals supported on the catalyst, and b) 0.05 wt % or less of Pt, Pd, or a combination thereof supported on the catalyst, the feed comprising a molar ratio of ethylene to isoparaffins of 1.0 or more and a molar ratio of ethylene to aromatics of 1.0 or more.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

The foregoing description of the disclosure illustrates and describes the present methodologies. Additionally, the disclosure shows and describes exemplary methods, but it is to be understood that various other combinations, modifications, and environments may be employed and the present methods are capable of changes or modifications within the scope of the concept as expressed herein, commensurate with the above teachings and/or the skill or knowledge of the relevant art.

We claim:

1. A method of converting an ethylene-containing feed, comprising:
exposing a feed comprising 5.0 wt % or more of ethylene to a catalyst comprising an MWW framework structure under conversion conditions comprising a temperature of 250° C. or less to form a conversion product comprising C₉-C₁₆ components,
the catalyst comprising a) 0.75 wt % or less of Group 5-10 and Group 13 non-noble metals supported on the catalyst, and b) 0.05 wt % or less of Pt, Pd, or a combination thereof supported on the catalyst,
the feed comprising a molar ratio of ethylene to isoparaffins of 1.0 or more and a molar ratio of ethylene to aromatics of 1.0 or more.

2. The method of claim 1, wherein the conversion product further comprises a naphtha boiling range portion, the naphtha boiling range portion of the conversion product comprising 10 wt % or more of cyclopentanes, or 2.0 wt % or more of 1,1-dimethylcyclopentane, or a combination thereof.

3. The method of claim 1, wherein the catalyst comprises 0.5 wt % or less of Group 5-10 and Group 13 non-noble metals supported on the catalyst.

4. The method of claim 1, wherein the conversion product further comprises at least one of C₂-C₄ hydrocarbons, C₅-C₈ hydrocarbons, and C₂-C₈ hydrocarbons,
the method further comprising separating the conversion product to form at least one of a fraction comprising C₂-C₄ hydrocarbons, a fraction comprising C₅-C₈ hydrocarbons, and a fraction comprising C₂-C₈ hydrocarbons,
wherein the feed comprises at least a portion of the at least one of a fraction comprising C₂-C₄ hydrocarbons, a fraction comprising C₅-C₈ hydrocarbons, and a fraction comprising C₂-C₈ hydrocarbons.

5. The method of claim 1, wherein exposing the feed to conversion conditions comprises exposing the feed to conversion conditions in a single reaction stage.

6. The method of claim 1, wherein the feed comprises a molar ratio of olefins to isoparaffins of 5.0 or more.

7. The method of claim 1, wherein the feed comprises a molar ratio of olefins to aromatics of 5.0 or more.

8. The method of claim 1, wherein the feed comprises 30 wt % or more of ethylene.

9. The method of claim 1, wherein the feed comprises 50 wt % or more of olefins.

10. The method of claim 9, wherein the feed comprises a molar ratio of ethylene to C₃ olefins of 0.05 or more.

11. The method of claim 1, wherein the feed comprises no isoparaffins, or wherein the feed comprises no aromatics, or a combination thereof.

12. The method of claim 1, wherein catalyst comprises EMM-10, or wherein the MWW framework structure comprises an aluminosilicate, or a combination thereof.

13. The method of claim 1, wherein the MWW framework structure comprises one or more atoms different from silicon, aluminum, and oxygen.

14. The method of claim 1, wherein the catalyst comprises 0.5 wt % or less of Group 5-14 non-noble metals supported on the catalyst.

15. The method of claim 1, wherein the catalyst comprises 0.01 wt % or less of Group 8-11 noble metals supported on the catalyst.

16. The method of claim 1, wherein the feed comprises 100 wppm or more of CO.

17. The method of claim 1, wherein the conversion conditions comprise an ethylene conversion of 30% or more.

18. The method of claim 1, wherein the feed is exposed to a catalyst system under the conversion conditions, the catalyst system comprising i) the catalyst comprising the MWW framework structure, and ii) at least one additional catalyst.

19. The method of claim 1, wherein the catalyst comprising the MWW framework structure further comprises at least one additional zeolite framework structure.

20. The method of claim 1, wherein the conversion product comprises a 30 wt % or higher yield of 165° C.+ compounds relative to a weight of ethylene in the feed.
